(19) United States
(12) Patent Application Publication
(10) Pub. No.: US 2026/0191391 A1
(43) Pub. Date: Jul. 9, 2026

(54) Maintenance Base Station for Cleaning Device, and Cleaning System

(71) Applicant: Shenzhen Roborock Innovation Technology Co., Ltd., Shenzhen (CN)

(72) Inventors: Xing Li, Shenzhen (CN); Yongfei Zhou, Shenzhen (CN); Jiayu Chen, Shenzhen (CN)

(21) Appl. No.: 19/557,742

(22) Filed: Mar. 5, 2026

Related U.S. Application Data
(63) Continuation of application No. PCT/CN2024/088101, filed on Apr. 16, 2024.

(30) Foreign Application Priority Data
Sep. 8, 2023 (CN) 202322447139.8

(51) Int. Cl. A47L 11/40; B08B 9/032

(52) U.S. Cl. CPC A47L 11/4091; B08B 9/032; B08B 2209/032

(57) ABSTRACT

A maintenance base station for a cleaning device, and a cleaning system are provided. The maintenance base station includes a waste inlet pipe, one end of the waste inlet pipe being configured to be connected to the cleaning device, for discharging a solid-liquid mixture from the cleaning device; a mixed waste channel, in communication with the other end of the waste inlet pipe; and a spray head, at least partially disposed in the mixed waste channel, and configured to clean the mixed waste channel.

### CROSS-REFERENCE TO RELATED APPLICATIONS

The present disclosure is a continuation application of International Application No. PCT/CN2024/088101, filed on Apr. 16, 2024, which claims priority to Chinese Patent Application No. 202322447139.8 filed on Sep. 8, 2023, which is incorporated herein by reference in its entirety as a part of the present disclosure.

### TECHNICAL FIELD

The present disclosure relates to the field of smart home technologies, and in particular, to a maintenance base station for a cleaning device, and a cleaning system.

### BACKGROUND

At present, after a cleaning device cleans a surface to be cleaned, solid waste (such as hair and food residues) is collected along with wastewater into a maintenance base station. When the maintenance base station discharges the wastewater containing the solid waste, the solid waste may cause a blockage in the drainage pipeline. In addition, over time, residual solid waste is prone to problems such as deterioration-related bacterial growth and odor generation.

### SUMMARY

According to one aspect of the present disclosure, a maintenance base station for a cleaning device is provided, which includes:
a solid-liquid separation assembly, configured to separate a mixture containing wastewater and solid waste to form wet waste and the wastewater; and
an air drying assembly, including an airflow generator and a heating mechanism, the airflow generator being configured to drive air to flow to form an airflow; and the heating mechanism being configured to heat the airflow to form a hot airflow, and the hot airflow drying the wet waste to form dry waste.

According to another aspect of the present disclosure, a cleaning system is provided, which includes:
a cleaning device; and
the maintenance base station for the cleaning device, which is the maintenance base station for the cleaning device according to any one of the above embodiments.

In one embodiment of the present disclosure, an air duct is provided in the maintenance base station, and one end of the air duct is in communication with the second air outlet. Alternatively, a third air outlet is provided in the maintenance base station, and one end of the air duct is in communication with the third air outlet; and the other opposite end of the air duct is in communication with the cleaning device, thereby allowing the hot airflow to dry the cleaning device.

### BRIEF DESCRIPTION OF THE DRAWINGS

The drawings, which are incorporated into and constitute a part of the specification, illustrate embodiments consistent with the present disclosure and are used in conjunction with the specification to explain the principles of the present disclosure. Apparently, the drawings in the following description are merely some embodiments of the present disclosure, and those of ordinary skill in the art may still derive other drawings from these drawings without creative efforts.

FIG. 1 is a schematic structural view of one embodiment of a maintenance base station for a cleaning device according to the present disclosure.

FIG. 2 is a schematic cross-sectional view of the maintenance base station for the cleaning device in FIG. 1.

FIG. 3 is a schematic side cross-sectional view of the maintenance base station for the cleaning device in FIG. 1.

FIG. 4 is a schematic structural view of an air drying assembly, a dry waste recovery chamber, and a dehumidifying mechanism of another embodiment of a maintenance base station for a cleaning device according to the present disclosure.

FIG. 5 is a schematic structural view of a solid-liquid separation assembly and a mixed waste receiving chamber according to yet another embodiment of a maintenance base station for a cleaning device of the present disclosure.

FIG. 6 is a schematic structural view of a cleaning system according to the present disclosure.

Description of the reference numerals:
1. solid-liquid separation assembly; 11. wet waste receiving chamber; 111. waste outlet; 12. filter screen;
2. air drying assembly; 21. airflow generator; 211. first air outlet; 212. first air inlet; 22. heating mechanism; 221. second air inlet; 222. second air outlet;
3. dry waste recovery chamber; 31. third air inlet; 32. third air outlet;
4. waste transfer mechanism; 41. motor; 42. rotation shaft; 43. scraper;
5. dehumidifying mechanism; 51. fourth air inlet; 52. fourth air outlet; 53. cooling pipeline; 531. coolant inlet; 532. coolant outlet; 54. condensed water outlet;
6. mixed waste receiving chamber; 61. bottom wall; 62. liquid outlet;
7. spray head; 8. wastewater discharge mechanism; 9. air duct;
10. maintenance base station; 101. shell; 102. waste suction fan; 103. waste inlet pipe; 104. mixed waste channel; 105. clean water tank; 106. clean water pump; 107. tap water connector; 108. floating ball;
20. cleaning device.

### DETAILED DESCRIPTION

Embodiments will now be described more comprehensively with reference to the drawings. However, the embodiments may be implemented in various forms, and should not be understood as being limited to the embodiments described herein. On the contrary, these embodiments are provided to make the present disclosure comprehensive and complete, and comprehensively convey the idea of the embodiments to those skilled in the art. The same reference numerals in the drawings indicate the same or similar mechanisms, and thus, a detailed description thereof will be omitted. In addition, the drawings are only schematic illustrations of the present disclosure and are not necessarily drawn to scale.

Although relative terms such as “upper” and “lower” are used in the specification to describe the relative relationship between one component and another component illustrated in the drawing, these terms are used in the specification for convenience only, for example, according to the directions of the examples described in the drawings. It can be understood that if the device illustrated in the drawing is turned upside down, the described “upper” component will become a “lower” component. When a mechanism is “on” another mechanism, it may mean that the mechanism is integrally formed on the other mechanism, or that the mechanism is “directly” disposed on the other mechanism, or that the mechanism is “indirectly” disposed on the other mechanism through another mechanism.

The terms “a”, “an”, “the”, and “at least one” are used to indicate the presence of one or more elements, components, or the like; the terms “include”, “comprise”, and “provided with” are used to indicate open-ended inclusion and mean that there may be additional elements, components, or the like, in addition to the listed elements, components, or the like; and the terms “first”, “second”, and “third” are used only as labels, and are not intended to limit the number of objects thereof.

In the present disclosure, unless otherwise clearly specified and defined, the term “connect” should be understood in its broad sense. For example, “connect” may be fixed connection, detachable connection, or integration; or direct connection, or indirect connection via an intermediate. The term “and/or” is merely a way to describe an association relationship between associated objects, indicating that three possible relationships may exist. For example, “A and/or B” can represent: the existence of A alone, the simultaneous existence of A and B, and the existence of B alone. In addition, the character “/” herein generally indicates an “or” relationship between the associated objects before and after the character “/”.

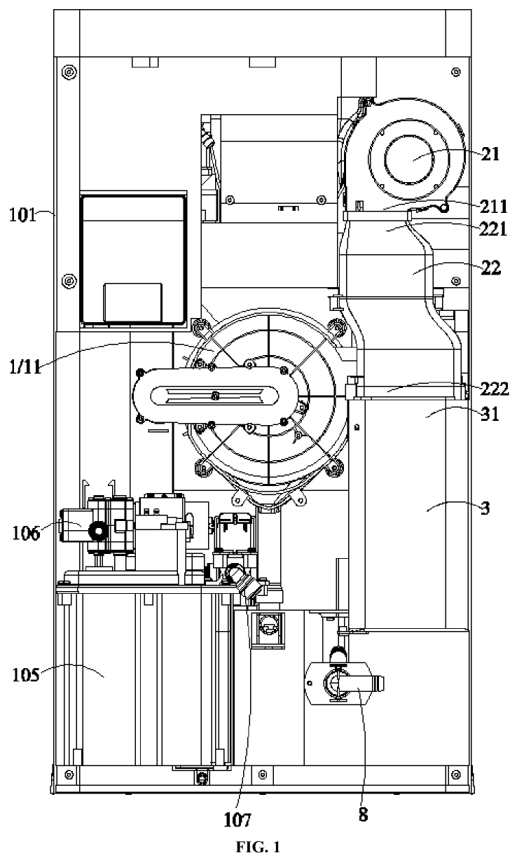

Embodiments of the present disclosure provide a maintenance base station 10 for a cleaning device 20. Referring to FIGS. 1 to 5, the maintenance base station 10 for the cleaning device 20 may include a solid-liquid separation assembly 1 and an air drying assembly 2. The solid-liquid separation assembly 1 is configured to separate a mixture containing wastewater and solid waste to form wet waste and wastewater. The air drying assembly 2 may include an airflow generator 21 and a heating mechanism 22. The airflow generator 21 is configured to drive air to flow to form an airflow. The heating mechanism 22 is configured to heat the airflow to form a hot airflow, and the hot airflow dries the wet waste to form dry waste.

In the maintenance base station 10 for the cleaning device 20 of the present disclosure, in one aspect, the solid waste and the wastewater are separated by the solid-liquid separation assembly 1, thereby preventing the solid waste from causing a blockage in the drainage pipeline when the maintenance base station 10 discharges the wastewater. In another aspect, the hot airflow is formed through the airflow generator 21 and the heating mechanism 22, and the hot airflow dries the wet waste to form the dry waste, thereby avoiding problems such as deterioration-related bacterial growth and odor generation in the wet waste.

In the embodiments, referring to FIGS. 1 to 3, the maintenance base station 10 may include a shell 101. The shell 101 is provided with the solid-liquid separation assembly 1 and the air drying assembly 2. The specific structure of the shell 101 may be set as required.

The solid-liquid separation assembly 1 may be configured to separate the mixture containing the wastewater and the solid waste to form the wet waste and the wastewater. The solid-liquid separation assembly 1 may be a gravity-based filtration separation assembly.

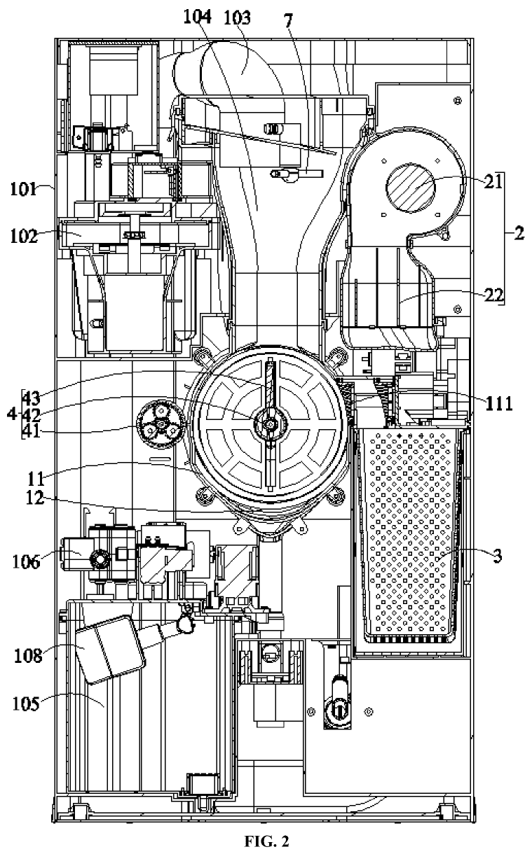

Specifically, referring to FIGS. 1 and 2, the gravity-based filtration separation assembly may include a wet waste receiving chamber 11. The wet waste receiving chamber 11 may be configured as a cylindrical structure, and a central rotation shaft of the wet waste receiving chamber 11 is parallel to the horizontal plane; that is, the wet waste receiving chamber 11 of the cylindrical structure is horizontally placed. The bottom of the wet waste receiving chamber 11 is provided with a filter screen 12. The filter screen 12 is configured as an arc-shaped plate matching the wet waste receiving chamber 11; that is, the filter screen 12 is a part of the cylindrical structure. After the mixture containing the wastewater and the solid waste is introduced into the wet waste receiving chamber 11, under the action of gravity, the wastewater flows out through the filter screen 12, leaving only the solid waste in the wet waste receiving chamber 11. Since the solid waste is soaked in the wastewater for a long time, the solid waste becomes wet waste.

The solid waste and the wastewater are separated by the solid-liquid separation assembly 1, thereby preventing the solid waste from causing a blockage in the drainage pipeline when the maintenance base station 10 discharges the wastewater.

In addition, the wet waste receiving chamber 11 is configured as a cylindrical structure and is horizontally placed, such that the wet waste receiving chamber 11 is provided with a lowest point. The filter screen 12 may be disposed at the lowest point of the wet waste receiving chamber 11, such that the wastewater can fully flow out from the wet waste receiving chamber 11, thereby reducing or even avoiding residual wastewater in the wet waste receiving chamber 11. Moreover, the inner wall of the wet waste receiving chamber 11 is smooth and free of corners or bent structures, thereby avoiding residual wastewater at positions such as corners or bent structures. Furthermore, the wet waste receiving chamber 11 is provided with a waste outlet 111. The waste outlet 111 may be disposed on the left side or the right side of the central axis of the wet waste receiving chamber 11.

In some other embodiments of the present disclosure, the solid-liquid separation assembly 1 may be a centrifugal filtration separation assembly. The centrifugal filtration separation assembly may include the wet waste receiving chamber 11 and a wastewater collection chamber. The wet waste receiving chamber 11 may be configured as a cylindrical structure, and the wet waste receiving chamber 11 of the cylindrical structure may be horizontally placed, such that the central rotation shaft of the wet waste receiving chamber 11 is parallel to the horizontal plane; the wet waste receiving chamber 11 of the cylindrical structure may also be vertically placed, such that the central rotation shaft of the wet waste receiving chamber 11 is perpendicular to the horizontal plane. The wall body of the wet waste receiving chamber 11 is provided with a plurality of through holes, and the plurality of through holes are substantially evenly arranged. The wastewater collection chamber is disposed outside the wet waste receiving chamber 11 and encloses the wet waste receiving chamber, and a gap is provided between the wastewater collection chamber and the wet waste receiving chamber 11.

The centrifugal filtration separation assembly may further include a drive motor. A rotation shaft of the drive motor is fixedly connected to the wet waste receiving chamber 11, and is coaxially arranged with the central rotation shaft of the wet waste receiving chamber 11. The drive motor can drive the wet waste receiving chamber 11 to rotate at a high speed, a centrifugal force is generated during the high-speed rotation, and the wastewater is ejected from the plurality of through holes in the wall body of the wet waste receiving chamber 11, such that the mixture containing the wastewater and the solid waste is separated to form the wet waste and the wastewater. In addition, the ejected wastewater is intercepted and collected by the wastewater collection chamber, thereby preventing the wastewater from splashing onto other components inside the maintenance base station 10.

In the embodiments, referring to FIGS. 1 to 3, the air drying assembly 2 may include the airflow generator 21 and the heating mechanism 22. The airflow generator 21 may include a fan. The airflow generator 21 is provided with a first air outlet 211, and the airflow generator 21 is configured to drive air to flow to form an airflow. The structure of the airflow generator 21 will not be elaborated again.

The heating mechanism 22 may include an electric heating wire. The heating mechanism 22 may also be a PTC heater. The PTC heater is composed of a PTC ceramic heating element and an aluminum tube. This type of PTC heating unit has the advantages of low thermal resistance and high heat exchange efficiency, and is an electric heater that automatically maintains a constant temperature while saving energy. The prominent feature lies in safety performance, and the phenomenon of “redness” on the surface of the electrothermal tube heater will not occur in any application situation, thereby causing potential safety hazards such as burns and fires.

The heating mechanism 22 is provided with a second air inlet 221 and a second air outlet 222, the second air inlet 221 is connected to the first air outlet 211, and the heating mechanism 22 is configured to heat the airflow to form a hot airflow. Specifically, the fan rotates to drive the air to flow to form the airflow, the airflow enters the heating mechanism 22 via the first air outlet 211 and the second air inlet 221, the heating mechanism 22 heats the airflow to form the hot airflow, and the hot airflow dries the wet waste to form the dry waste. The dry waste is not prone to deterioration-related bacterial growth and odor generation, thereby avoiding problems such as deterioration-related bacterial growth and odor generation in the wet waste.

Further, the maintenance base station 10 may further include a dry waste recovery chamber 3 and a waste transfer mechanism 4. The dry waste recovery chamber 3 may be configured to receive the dry waste. The dry waste recovery chamber 3 is provided with a waste inlet, and the waste inlet is connected to the waste outlet 111 of the wet waste receiving chamber 11. The waste transfer mechanism 4 may be configured to transfer the wet waste from the wet waste receiving chamber 11 to the dry waste recovery chamber 3.

In the embodiments, referring to FIGS. 1 to 3, the air drying assembly 2 may be directly connected to the dry waste recovery chamber 3, and directly dry the wet waste in the dry waste recovery chamber 3.

Specifically, the dry waste recovery chamber 3 is provided with a third air inlet 31 and a third air outlet 32; that is, the dry waste recovery chamber 3 is provided with the third air inlet 31 and the third air outlet 32, and the third air inlet 31 is connected to the second air outlet 222, such that the hot airflow formed through the airflow generator 21 and the heating mechanism 22 can flow into the dry waste recovery chamber 3, and the hot airflow can dry the wet waste received in the dry waste recovery chamber 3 to form the dry waste.

In this case, the wet waste needs to be first transferred from the solid-liquid separation assembly 1 to the dry waste recovery chamber 3 by the waste transfer mechanism 4.

The dry waste recovery chamber 3 is detachably disposed; that is, the dry waste recovery chamber 3 can be removed from the maintenance base station 10, and the dry waste recovery chamber 3 can be replaced. For example, the dry waste recovery chamber 3 may be disposable, and after the dry waste reaches a certain amount, the dry waste recovery chamber 3 along with the dry waste in dry waste recovery chamber may be discarded directly; or the dry waste recovery chamber 3 may be sleeved with a garbage bag, and after the dry waste reaches a certain amount, the garbage bag along with the dry waste in the garbage bag may be discarded. Therefore, drying the wet waste in the dry waste recovery chamber 3 can minimize residual waste.

In addition, the dry waste formed by drying the wet waste tends to adhere to the side wall of the waste receiving chamber, and the dry waste is more difficult to clean than the wet waste. Therefore, when drying is performed in the wet waste receiving chamber 11 of the solid-liquid separation assembly 1, the dry waste formed in the wet waste receiving chamber 11 tends to adhere to the side wall of the wet waste receiving chamber 11, making it difficult to clean. After being accumulated for a long time, the waste in the wet waste receiving chamber 11 tends to deteriorate and produce odor, and the waste may also cause a blockage in the filter screen or the through hole of the wet waste receiving chamber 11, such that the wet waste receiving chamber 11 cannot filter or eject the wastewater, resulting in the failure of the solid-liquid separation assembly 1. When drying is performed in the dry waste recovery chamber 3, the above technical problem does not occur. In addition, since the dry waste recovery chamber 3 can be replaced, residual dry waste can be minimized.

Referring to FIG. 2, in the case that the solid-liquid separation assembly 1 is a gravity-based filtration separation assembly, the dry waste recovery chamber 3 may be disposed on the left side or the right side of the central axis of the wet waste receiving chamber 11; that is, the dry waste recovery chamber 3 is disposed on the lower side of the waste outlet 111 of the wet waste receiving chamber 11. Specifically, the waste transfer mechanism 4 may include a motor 41, a rotation shaft 42, and a scraper 43. The motor 41 is disposed outside the wet waste receiving chamber 11, and the rotation shaft 42 and the scraper 43 are disposed inside the wet waste receiving chamber 11. A drive shaft of the motor 41 is fixedly connected to the rotation shaft 42, the motor 41 can drive the rotation shaft 42 to rotate, and the scraper 43 is connected to the rotation shaft 42. While the motor 41 drives the rotation shaft 42 to rotate, the rotation shaft 42 drives the scraper 43 to rotate, and the scraper 43 transfers the dry waste from the wet waste receiving chamber 11 to the dry waste recovery chamber 3.

In the case that the solid-liquid separation assembly 1 is a centrifugal filtration separation assembly, the dry waste recovery chamber 3 may be disposed on the lower side of the wet waste receiving chamber 11, and the waste transfer mechanism 4 may be disposed at the bottom of the wet waste receiving chamber 11. Specifically, the bottom of the wet waste receiving chamber 11 is provided with an opening portion. The waste transfer mechanism 4 may include a motor and a baffle. The baffle may be rotatably disposed at the opening portion of the wet waste receiving chamber 11, the motor is connected to the baffle, and the motor can drive the baffle to rotate, such that the baffle is misaligned with the opening portion, and the dry waste in the wet waste receiving chamber 11 falls into the dry waste recovery chamber 3 under the action of gravity.

In some other embodiments of the present disclosure, the air drying assembly 2 may be directly connected to the solid-liquid separation assembly 1, and the wet waste is directly dried in the solid-liquid separation assembly 1. In this way, the hot airflow can dry the solid-liquid separation assembly 1 while drying the waste, thereby avoiding problems such as deterioration-related bacterial growth and odor generation in the residual wet waste in the case that the wet waste remains in the solid-liquid separation assembly 1.

In this case, the wet waste receiving chamber 11 is provided with a third air inlet and a third air outlet; that is, the wet waste receiving chamber 11 is provided with the third air inlet and the third air outlet, and the third air inlet is connected to the second air outlet 222, such that the hot airflow formed through the airflow generator 21 and the heating mechanism 22 can flow into the wet waste receiving chamber 11, and the hot airflow can dry the wet waste received in the wet waste receiving chamber 11 to form the dry waste.

In addition, the maintenance base station 10 may further include a dry waste recovery chamber 3 and a waste transfer mechanism 4. The dry waste recovery chamber 3 may be configured to receive the dry waste. The dry waste recovery chamber 3 is provided with the waste inlet, and the waste inlet is connected to the waste outlet 111 of the wet waste receiving chamber. The waste transfer mechanism 4 may be configured to transfer the dry waste from the wet waste receiving chamber 11 to the dry waste recovery chamber 3. The specific structure of the waste transfer mechanism 4 may be the same as the specific structure of the waste transfer mechanism 4 in the above embodiment, and thus will not be elaborated again.

In the embodiments, the dry waste recovery chamber 3 is not hermetically sealed. Therefore, the hot airflow after drying the wet waste may flow into the shell 101 to dry other components inside the shell 101.

In addition, referring to FIG. 2, the shell 101 may be provided with a waste suction fan 102, and the hot air in the shell 101 may be discharged via the waste suction fan 102.

After the hot airflow dries the wet waste, the temperature of the hot airflow may decrease. However, the moisture in the wet waste may form water vapor that mixes with the hot airflow. The water vapor has a certain corrosive effect on various components and mechanisms in the maintenance base station 10, and the safety performance and service life of the maintenance base station 10 may be affected in the case that the water vapor remains in the maintenance base station 10 for a long time. In addition, the water vapor may also cause the dry waste to become damp again, and the damp dry waste is prone to problems such as deterioration-related bacterial growth and odor generation.

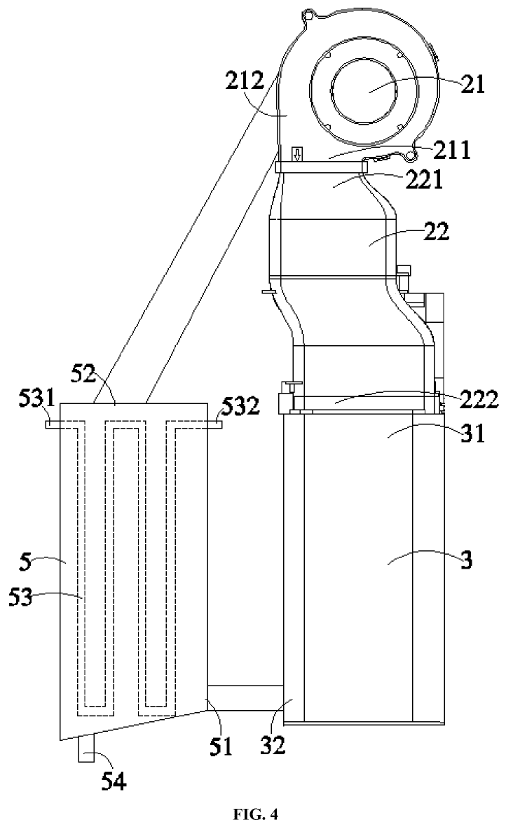

To solve the above technical problem, in yet other embodiments of the present disclosure, referring to FIG. 4, a cooling pipeline 53 in FIG. 4 is represented by a dashed line due to being blocked, and the maintenance base station 10 may further include a dehumidifying mechanism 5. The dehumidifying mechanism 5 is provided with a fourth air inlet 51 and a fourth air outlet 52; that is, the dehumidifying mechanism 5 is provided with the fourth air inlet 51 and the fourth air outlet 52, and the fourth air inlet 51 is connected to the third air outlet 32, such that the hot airflow after drying the wet waste may flow into the dehumidifying mechanism 5 via the third air outlet 32 and the fourth air inlet 51, and the dehumidifying mechanism 5 is configured to dehumidify the hot airflow after drying the wet waste.

After the dehumidifying mechanism 5 dehumidifies the hot airflow after drying the wet waste, the content of water vapor in the hot airflow is reduced, such that the corrosive effect of the water vapor on various components and mechanisms in the maintenance base station 10 is avoided, thereby ensuring the safety performance and service life of the maintenance base station 10. In addition, the dry waste is prevented from becoming damp again, thereby avoiding problems such as deterioration-related bacterial growth and odor generation.

In the embodiments, the dehumidifying mechanism 5 may be a condensation-type dehumidifying mechanism 5. Specifically, the dehumidifying mechanism 5 may include a housing and cooling pipelines 53. The cooling pipelines 53 are disposed in the housing, and an airflow channel is disposed between the cooling pipelines 53. The cooling pipeline 53 is provided with a coolant inlet 531 and a coolant outlet 532. The fourth air inlet 51 is disposed at a lower portion of the housing, such that the hot airflow with high humidity flows into the housing via the lower portion of the housing, the hot airflow is in contact with the cooling pipeline 53, and the water vapor in the hot airflow is cooled and becomes condensed water, thereby reducing the humidity of the hot airflow and achieving the purpose of dehumidifying the hot airflow after drying the wet waste.

In addition, the housing is provided with a condensed water outlet 54, and the condensed water outlet 54 is disposed at the lower portion of the housing. Due to the action of gravity, the condensed water flows downward, and the condensed water outlet 54 is disposed at the lower portion of the housing, such that the condensed water can flow out almost completely, thereby preventing the condensed water from remaining in the dehumidifying mechanism 5.

The fourth air outlet 52 is disposed at an upper portion of the housing, such that the dried airflow can flow out via the fourth air outlet 52 disposed at the upper portion of the housing, thereby preventing the generated condensed water from causing the dried airflow to become damp again, and ensuring the dryness of the dried airflow.

Although the temperature of the airflow dehumidified by the dehumidifying mechanism 5 decreases, the temperature is still relatively high, and the direct discharge of the airflow with a relatively high temperature may result in a waste of resources and also affect the use environment of the maintenance base station 10. The fourth air outlet 52 is connected to the first air inlet 212 of the airflow generator 21, such that the airflow dehumidified by the dehumidifying mechanism 5 directly flows to the airflow generator 21, and the airflow with a relatively high flow rate is formed through the acceleration by the airflow generator 21, so as to perform subsequent drying of the wet waste; that is, the airflow generator 21, the heating mechanism 22, the wet waste receiving chamber 11 (or the dry waste recovery chamber 3), and the dehumidifying mechanism 5 form a closed-loop airflow circulation system. In addition, the amount of heating applied to the airflow by the heating mechanism 22 may be reduced, thereby achieving the purpose of saving energy and reducing discharge, without affecting the use environment of the maintenance base station 10. The fourth air outlet 52 of the dehumidifying mechanism 5 may be directly or indirectly connected to the first air inlet 212 of the airflow generator 21.

The cooling pipeline 53 is provided with the coolant inlet 531 and the coolant outlet 532. Coolant can be supplied to the cooling pipeline 53 via the coolant inlet 531. If the maintenance base station 10 is not used for a long time, the coolant can be discharged via the coolant outlet 532, thereby preventing coolant leakage.

Certainly, in some other embodiments of the present disclosure, the dehumidifying mechanism 5 may be an adsorption-type dehumidifying mechanism 5. Specifically, the dehumidifying mechanism 5 may include a housing and a dehumidification agent. The dehumidification agent is provided in the housing. The housing is provided with the fourth air inlet 51 and the fourth air outlet 52. The hot airflow with high humidity flows into the housing via the fourth air inlet 51, and the dehumidification agent adsorbs the water vapor in the hot airflow with high humidity, thereby allowing the dried air to flow out via the fourth air outlet 52. The dehumidification agent may be a currently used dehumidification agent, which will not be elaborated here.

In addition, in some other embodiments of the present disclosure, when the hot airflow dries the wet waste in the wet waste receiving chamber 11 to form the dry waste, the fourth air inlet 51 of the dehumidifying mechanism 5 may be connected to the wet waste receiving chamber 11.

Further, the airflow generator 21 is hermetically connected to the heating mechanism 22. The heating mechanism 22 is hermetically connected to the dry waste recovery chamber 3, and the dry waste recovery chamber 3 is hermetically connected to the dehumidifying mechanism 5; alternatively, the heating mechanism 22 is hermetically connected to the wet waste receiving chamber 11, and the wet waste receiving chamber 11 is hermetically connected to the dehumidifying mechanism 5. The dehumidifying mechanism 5 is hermetically connected to the airflow generator 21.

Specifically, the second air inlet 221 is hermetically connected to the first air outlet 211, the third air inlet 31 is hermetically connected to the second air outlet 222, the fourth air inlet 51 is hermetically connected to the third air outlet 32, and the fourth air outlet 52 is hermetically connected to the first air inlet 212. That is, the airflow generator 21, the heating mechanism 22, the wet waste receiving chamber 11 (or the dry waste recovery chamber 3), and the dehumidifying mechanism 5 form a closed-loop and hermetically sealed airflow circulation system. After all, the waste still has a certain odor. Such a configuration prevents the airflow from escaping, thereby preventing the airflow from carrying the odor of the waste and thus avoiding odor emission from the entire maintenance base station 10. In addition, by confining the entire hot air within the circulation system, the drying efficiency can be improved.

In the embodiments, referring to FIG. 2, the maintenance base station 10 may further include a waste inlet pipe 103 and a mixed waste channel 104. The mixed waste channel 104 may be disposed above the solid-liquid separation assembly 1. One end of the waste inlet pipe 103 is connected to the cleaning device, and the other end of the waste inlet pipe 103 extends into the mixed waste channel 104. A mixture containing wastewater and solid waste in the cleaning device may be fed to the mixed waste channel 104 via the waste inlet pipe 103, and flow to the solid-liquid separation assembly 1 via the mixed waste channel 104.

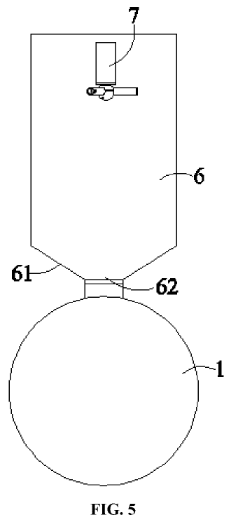

In some embodiments of the present disclosure, as shown in FIG. 5, the maintenance base station 10 may further include a mixed waste receiving chamber 6. The mixed waste receiving chamber 6 is configured to receive wastewater or a mixture containing wastewater and solid waste. A baffle that can be controlled to be opened or closed may be disposed at the bottom of the mixed waste channel 104 to form the mixed waste receiving chamber 6. When there is a small amount of the mixture containing the wastewater and the solid waste generated by the cleaning device 20, the mixture may be stored in the mixed waste receiving chamber 6 to await being fed with a next batch of the mixture containing the wastewater and the solid waste generated by the cleaning device 20, and solid-liquid separation, wastewater discharge, and drying of wet waste are performed when the mixture reaches a set amount.

In the direction perpendicular to the horizontal plane, the height of the mixed waste receiving chamber 6 is higher than the height of the solid-liquid separation assembly 1. For example, the mixed waste receiving chamber 6 may be disposed directly above the solid-liquid separation assembly 1, and a lower portion of the mixed waste receiving chamber 6 is provided with a liquid outlet 62. When solid-liquid separation is required, the liquid outlet 62 may be directly opened, such that the mixture directly flows into the wet waste receiving chamber 11 of the solid-liquid separation assembly 1 under the action of gravity.

Certainly, the mixed waste receiving chamber 6 may be disposed obliquely above the solid-liquid separation assembly 1, the lower portion of the mixed waste receiving chamber 6 is provided with the liquid outlet 62, and the liquid outlet 62 may be connected to the wet waste receiving chamber 11 of the solid-liquid separation assembly 1 via a pipeline. When solid-liquid separation is required, the liquid outlet 62 may be directly opened, such that the mixture flows into the wet waste receiving chamber 11 of the solid-liquid separation assembly 1 via the pipeline under the action of gravity.

Further, a bottom wall 61 of the mixed waste receiving chamber 6 may be configured in a conical shape, such that the bottom wall 61 is provided with a lowest point. For example, the bottom wall 61 of the mixed waste receiving chamber 6 is configured as an inverted cone or an inverted pyramid, with the vertex of the inverted cone or inverted pyramid being the lowest point. The bottom wall 61 is provided with the liquid outlet 62, and the liquid outlet 62 is located at the lowest point of the bottom wall 61. For example, the liquid outlet 62 is located at the vertex of the inverted cone or the inverted pyramid.

In this way, the mixture in the mixed waste receiving chamber 6 can flow into the solid-liquid separation assembly 1 almost completely, thereby preventing the mixture from remaining in the mixed waste receiving chamber 6, and avoiding problems such as deterioration-related bacterial growth and odor generation in the residual solid waste within the mixed waste receiving chamber 6.

Certainly, in some other embodiments of the present disclosure, the bottom wall 61 of the mixed waste receiving chamber 6 may be configured to be inclined, or the bottom wall 61 may be provided with the lowest point, thereby facilitating the discharge of the mixture from the mixed waste receiving chamber 6.

In the embodiments, referring to FIG. 2, the maintenance base station 10 may further include a spray head 7. The spray head 7 is disposed in the mixed waste channel 104, and the spray head 7 is configured to clean the mixed waste channel 104.

Certainly, in some embodiments of the present disclosure, referring to FIG. 5, in the case that the mixed waste receiving chamber 6 is provided, the spray head 7 may be disposed in the mixed waste receiving chamber 6, and the spray head 7 is configured to clean the mixed waste receiving chamber 6. Specifically, the spray head 7 may include a main spray pipe. The main spray pipe is provided with a first end and a second end disposed opposite to each other, the first end of the main spray pipe is configured to be connected to a clean water pipe, and the second end of the main spray pipe is connected to a plurality of sub-spray pipes. Cleaning is performed by spraying water via the spray pipes.

In addition, the spray head 7 may include a spray pipe. The spray pipe is provided with a first end and a second end disposed opposite to each other, the first end of the spray pipe is configured to be connected to a clean water pipe, and the second end of the spray pipe is configured as a closed end, thereby preventing the clean water from flowing out directly from the second end, which would result in a failure to clean the mixed waste receiving chamber 6. The pipe wall of the spray pipe is provided with a plurality of through holes, and the plurality of through holes are evenly arranged along the peripheral wall of the spray pipe from top to bottom. The clean water flowing in from the first end is sprayed to the inner side wall of the mixed waste receiving chamber 6 via the plurality of through holes, thereby cleaning the mixed waste receiving chamber 6. In addition, the length of the spray pipe is substantially the same as the depth of the mixed waste receiving chamber 6.

Certainly, in some other embodiments of the present disclosure, the length of the spray pipe may be configured to be short, and a driving mechanism is provided. The driving mechanism drives the spray pipe to move up and down, such that the spray pipe can perform spray cleaning on various parts of the mixed waste receiving chamber 6. The structure of the spray head 7 may also be of other structures, which will not be elaborated here.

In the embodiments, referring to FIG. 1, the maintenance base station 10 may further include a wastewater discharge mechanism 8. The wastewater discharge mechanism 8 may be configured to empty wastewater separated by the solid-liquid separation assembly 1. The wastewater discharge mechanism 8 may include a wastewater pipe, one end of the wastewater pipe is directly connected to a wastewater outlet of the solid-liquid separation assembly 1, and the other end of the wastewater pipe is directly connected to a sewer pipeline, such that the wastewater separated by the solid-liquid separation assembly 1 directly flows to the wastewater pipe and is directly discharged to the sewer pipeline via the wastewater pipe.

Certainly, in some other embodiments of the present disclosure, the wastewater discharge mechanism 8 may further include a wastewater collection bucket. The wastewater collection bucket is disposed below the solid-liquid separation assembly 1, such that wastewater separated by the solid-liquid separation assembly 1 directly flows to the wastewater collection bucket, and one end of the wastewater pipe is directly connected to a wastewater outlet of the wastewater collection bucket. When it is inconvenient for the maintenance base station 10 to be directly connected to the sewer pipeline, the wastewater may be received in the wastewater collection bucket, and then the maintenance base station 10 is moved to the sewer pipeline for direct discharge to the sewer pipeline via the wastewater pipe. Alternatively, when there is a small amount of wastewater, the wastewater may be received in the wastewater collection bucket, and once there is a large amount of wastewater, the wastewater is directly discharged to the sewer pipeline via the wastewater pipe.

The wastewater discharge mechanism 8 may further include a water pump. The water pump is connected between the wastewater pipe and the wastewater collection bucket. The wastewater is pumped to the wastewater pipe by the water pump and then directly discharged to the sewer pipeline via the wastewater pipe.

In the embodiments, referring to FIGS. 1 and 2, the maintenance base station 10 may further include a clean water tank 105, a clean water pump 106, a tap water connector 107, and a floating ball 108. The clean water tank 105 is configured to store clean water. One end of the tap water connector 107 is configured to connect to a faucet, one end of the tap water connector 107 is in communication with the clean water tank 105, and the tap water connector 107 is configured to deliver tap water to the clean water tank 105. The floating ball 108 is disposed in the clean water tank 105, and the floating ball 108 is configured to detect a water level in the clean water tank 105. The clean water pump 106 is configured to pump clean water from the clean water tank 105 to the cleaning device 20.

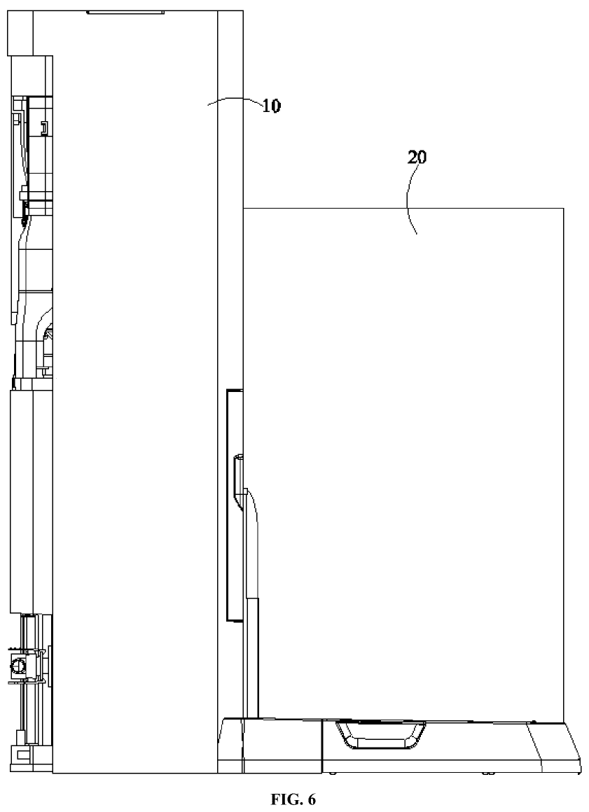

Based on the same inventive concept, the embodiments of the present disclosure provide a cleaning system. Referring to FIG. 6, the cleaning system may include a cleaning device 20 and a maintenance base station 10 for the cleaning device 20. The maintenance base station 10 for the cleaning device 20 is the maintenance base station 10 for the cleaning device 20 according to any one of the above embodiments. The specific structure of the maintenance base station 10 has been described in detail above, and thus will not be elaborated here again.

The cleaning device 20 is configured to clean a surface to be cleaned (e.g., a floor), and the cleaning device 20 forms a mixture containing wastewater and solid waste after cleaning the surface to be cleaned. The cleaning device 20 may be a floor-cleaning machine. Since the mixture is also stored in the cleaning device 20, the interior of the cleaning device 20 is also humid. In addition, over time, residual waste is prone to problems such as deterioration-related bacterial growth and odor generation.

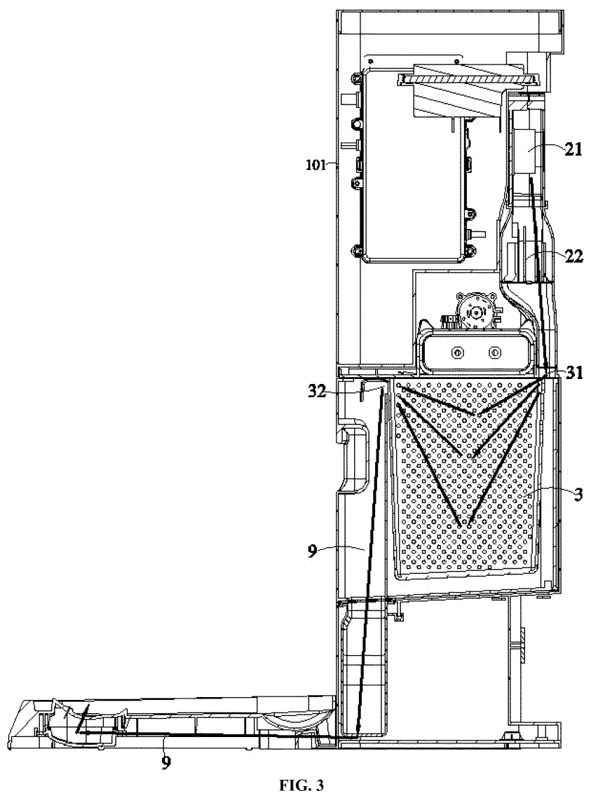

Referring to FIG. 3, an air duct 9 is indicated by a bold black arrow. The maintenance base station 10 is provided with the air duct 9, and one end of the air duct 9 may be in communication with the third air outlet 32; that is, one end of the air duct 9 is connected to the dry waste recovery chamber 3, such that the hot airflow after drying the wet waste can flow to the air duct 9 and then flow to the cleaning device 20 via the air duct 9, thereby allowing the hot airflow to dry the cleaning device 20. In this way, the hot airflow after drying the wet waste can be further utilized to dry the cleaning device 20, thereby improving the utilization efficiency of the hot airflow and helping save energy and reduce discharge. Certainly, in the case that the wet waste is dried in the solid-liquid separation assembly 1, one end of the air duct 9 may be connected to the solid-liquid separation assembly 1.

In addition, in some other embodiments of the present disclosure, one end of the air duct 9 is in communication with the second air outlet 222; that is, one end of the air duct 9 is connected to the air outlet of the heating mechanism 22, and the other opposite end of the air duct 9 is in communication with the cleaning device 20, such that the hot airflow heated by the heating mechanism 22 can flow to the air duct 9 and then flow to the cleaning device 20 via the air duct 9, thereby allowing the hot airflow to dry the cleaning device 20. In this way, the hot airflow heated by the heating mechanism 22 can directly dry the cleaning device 20, thereby helping improve the drying efficiency of the cleaning device 20.

“Parallel” and “perpendicular” mentioned in the present disclosure may not only be completely parallel and perpendicular, but also allow for a certain error. For example, if an included angle between two elements is greater than or equal to 0° and less than or equal to 5°, it is considered that the two elements are parallel to each other; and if the included angle between the two elements is greater than or equal to 85° and less than or equal to 95°, it is considered that the two are perpendicular to each other.

Other embodiments of the present disclosure are apparent to those skilled in the art from consideration of the specification and practice of the present disclosure herein. The present disclosure is intended to encompass any variation, use, or adaptation of the present disclosure following the general principles of the present disclosure and including known common knowledge or customary technical means in the art undisclosed in the present disclosure. The specification and embodiments are only considered, and the true scope and spirit of the present disclosure are indicated in the appended claims.

1. (canceled)

2. (canceled)

3. (canceled)

4. (canceled)

5. (canceled)

6. (canceled)

7. (canceled)

8. (canceled)

9. (canceled)

10. (canceled)

11. A maintenance base station for a cleaning device, wherein the maintenance base station comprises:
a waste inlet pipe, one end of the waste inlet pipe being configured to be connected to the cleaning device, for discharging a solid-liquid mixture from the cleaning device;
a mixed waste channel in communication with the other end of the waste inlet pipe; and
a spray head at least partially disposed in the mixed waste channel, and configured to clean the mixed waste channel.

12. The maintenance base station according to claim 11, wherein a first end of the spray head is connected to a clean water pipe, and a second end of the spray head is disposed facing an inner side wall of the mixed waste channel, and clean water is sprayed onto the inner side wall of the mixed waste channel through the spray head.

13. The maintenance base station according to claim 12, wherein the second end of the spray head is connected to a plurality of sub-spray pipes, and the clean water is sprayed toward the inner side wall of the mixed waste channel for rinsing through the plurality of sub-spray pipes.

14. The maintenance base station according to claim 11, wherein the spray head comprises a spray pipe, a first end of the spray pipe is connected to a clean water pipe, a second end of the spray pipe is a closed end, a pipe wall of the spray pipe is provided with a plurality of through holes, and the plurality of through holes are evenly arranged from top to bottom along a peripheral wall of the spray pipe.

15. The maintenance base station according to claim 11, further comprising:
a driving mechanism connected to the spray head, and configured to drive the spray head to move up and down, to perform spray cleaning on parts of the mixed waste channel.

16. The maintenance base station according to claim 11, wherein the spray head is disposed above the mixed waste channel.

17. The maintenance base station according to claim 11, wherein a bottom of the mixed waste channel is provided with a baffle configured to be controlled to open or close, so as to form a mixed waste receiving chamber; and the maintenance base station comprises a housing, and the mixed waste receiving chamber is disposed in an upper-middle part of the housing.

18. The maintenance base station according to claim 17, wherein a bottom wall of the mixed waste receiving chamber is configured in a conical shape, and has a lowest point; and the bottom wall is provided with a liquid outlet, and the liquid outlet is located at the lowest point of the bottom wall.

19. The maintenance base station according to claim 11, further comprising:
a solid-liquid separation assembly located on a flow path of the solid-liquid mixture, and configured to separate the solid-liquid mixture to form wet waste and wastewater.

20. The maintenance base station according to claim 19, wherein, in a direction perpendicular to a horizontal plane, at least a portion of the mixed waste channel is higher than the solid-liquid separation assembly.

21. The maintenance base station according to claim 19, wherein at least a portion of the mixed waste channel is disposed above the solid-liquid separation assembly, and an orthographic projection of the mixed waste channel on a horizontal plane at least partially overlaps with an orthographic projection of the solid-liquid separation assembly on the horizontal plane.

22. The maintenance base station according to claim 19, further comprising:
a wastewater discharge mechanism configured to empty the wastewater separated by the solid-liquid separation assembly.

23. The maintenance base station according to claim 22, wherein the wastewater discharge mechanism comprises:
a wastewater pipe, one end of the wastewater pipe being in communication to the solid-liquid separation assembly, and the other end of the wastewater pipe being directly connected to a sewer pipeline.

24. The maintenance base station according to claim 19, wherein the solid-liquid separation assembly is a gravity-based filtration separation assembly or a centrifugal filtration separation assembly.

25. A cleaning system, wherein comprising:
a cleaning device; and
a maintenance base station for the cleaning device, comprising:
a waste inlet pipe, one end of the waste inlet pipe being configured to be connected to the cleaning device, for discharging a solid-liquid mixture from the cleaning device;
a mixed waste channel in communication with the other end of the waste inlet pipe; and
a spray head at least partially disposed in the mixed waste channel, and configured to clean the mixed waste channel.

26. The cleaning system according to claim 25, wherein a first end of the spray head is connected to a clean water pipe, and a second end of the spray head is disposed facing an inner side wall of the mixed waste channel, and clean water is sprayed onto the inner side wall of the mixed waste channel through the spray head.

27. The cleaning system according to claim 26, wherein the second end of the spray head is connected to a plurality of sub-spray pipes, and the clean water is sprayed toward the inner side wall of the mixed waste channel for rinsing through the plurality of sub-spray pipes.

28. The cleaning system according to claim 25, wherein the spray head comprises a spray pipe, a first end of the spray pipe is connected to a clean water pipe, a second end of the spray pipe is a closed end, a pipe wall of the spray pipe is provided with a plurality of through holes, and the plurality of through holes are evenly arranged from top to bottom along a peripheral wall of the spray pipe.

29. The cleaning system according to claim 25, further comprising:
a driving mechanism connected to the spray head, and configured to drive the spray head to move up and down, to perform spray cleaning on parts of the mixed waste channel.

30. The cleaning system according to claim 25, wherein the spray head is disposed above the mixed waste channel.
